(19) United States
(12) Patent Application Publication
(10) Pub. No.: US 2017/0087787 A1
(43) Pub. Date: Mar. 30, 2017

(54) DOUBLE BELT PRESS FOR PREVENTING MEANDERING OF BELT

(71) Applicant: HYUNDAI MOTOR COMPANY, Seoul (KR)

(72) Inventors: Deok Woo YUN, Hwaseong-si (KR); Hyun Min KANG, Seongnam-si (KR)

(21) Appl. No.: 15/070,850

(22) Filed: Mar. 15, 2016

(30) Foreign Application Priority Data
Sep. 25, 2015 (KR) 10-2015-0137072

(51) Int. Cl. B30B 5/06; B29C 43/24; B30B 15/16; B30B 15/34; B30B 15/14

(52) U.S. Cl. CPC B30B 5/06; B30B 15/34; B30B 15/14; B30B 15/16; B29C 43/24; B29L 2031/731

(57) ABSTRACT

A double belt press includes a pair of belts disposed at an upper side and a lower side of a fiber material which is supplied to the pair of belts to rotate in opposite directions for pressing the fiber material from the upper side and the lower side while conveying the fiber material. At least two convey rollers are disposed in the pair of belts for moving the pair of belts. A detector is configured to detect whether a belt meanders. A pressure supply unit configured to supply pressure to the belts. A controller is configured to control pressure supplied to both sides of each belt through the pressure supply unit when the belt meanders according to a detection result from the detector.

### CROSS-REFERENCE TO RELATED APPLICATION

This application claims the benefit of priority to Korean Patent Application No. 10-2015-0137072 filed in the Korean Intellectual Property Office on Sep. 25, 2015, the entire content of which is incorporated herein by reference.

### TECHNICAL FIELD

The present disclosure relates to a double belt press. More particularly, the present disclosure relates to a double belt press that prevents meandering of a belt in a process of producing a continuous fiber.

### BACKGROUND

Composite materials having strength of a metal, and lightness and formability of a plastic have been introduced

Such composite materials include fiber reinforced plastic (FRP), of which the most typical one is carbon fiber reinforced plastic (CRFP).

The composite materials have been used due to high strength, high elasticity, and light weight and include a fiber (carbon fiber) which is used as a reinforcing material. These composite materials are high tech composite materials having excellent characteristics as light weight structural materials.

In general, the composite materials are heated and pressurized under a specific period of time, a temperature, and pressure conditions during a manufacturing process. The heating and pressurization processes of the composite materials are performed using a double belt press.

However, during the operation of the double belt press, a belt of the double belt press meanders, so that it is difficult to supply uniform pressure or heat to the composite materials.

Accordingly, properties difference of the composite materials or a thickness deviation may occur, thus the composite material may defect. Further, when the belt meanders, it may wear out. Thus, durability of the belt is deteriorated.

The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to provide a double belt press that prevents meander of a belt of the double belt press.

A double belt press according to an exemplary embodiment in the present disclosure includes a pair of belts respectively disposed at an upper side and a lower side of a fiber material which is supplied to the pair of belts to rotate in opposite directions for pressing the fiber material from the upper side and the lower side while conveying the fiber material. At least two convey rollers are disposed in the pair of belts for moving the pair of belts. A detector is configured to detect whether any one of the pair of belts meanders. A pressure supply unit is configured to supply pressure to the pair of belts. A controller is configured to control the pressure supplied to both sides of each belt through the pressure supply unit when any one of the pair of belts meanders according to a detection result from the detector.

The pressure supply unit may include a guide roll disposed at the pair of belts in a width direction of the belts and contacting the belts, A left cylinder and a right cylinder are disposed at respective sides of the guide roll and control the pressure supplied to the guide roll.

The detector may be a left pressure detecting sensor and a right pressure detecting sensor. The controller determines that at least one belt meanders when a pressure difference detected by the left pressure detecting sensor and the right detecting sensor is greater than a reference pressure.

When the pressure difference detected by the left pressure detecting sensor and the right detecting sensor is greater than the reference pressure, the controller may compare a pressure detected by the left pressure detecting sensor to a pressure detected by the right pressure detecting sensor and increase the pressure generated from the cylinder positioned, at which the detected pressure is lower, to be greater than the pressure generated from the cylinder positioned at which the detected pressure is higher.

The detector may be a position detecting sensor that detects a position of the belt. The controller may determine that at least one belt meanders when the position of the belt detected by the position detecting sensor is beyond a reference range.

When the position of the belt is beyond the reference range, the controller may increase the pressure generated from the cylinder positioned, at which the belt is beyond the reference range to be greater than the pressure generated from the cylinder positioned at which the belt is within the reference range.

According to the exemplary embodiment in the present disclosure, the double belt press may determine whether the belt meanders by detecting a pressure or position of the belt.

Further, the double belt press according to the exemplary embodiment in the present disclosure can prevent meandering of the belt by adjusting the pressure supplied to both sides of the belt, thus supplying uniform pressure and temperature to the fiber composite and minimizing defects of the fiber composite.

Further, the double belt press according to the exemplary embodiment in the present disclosure can minimize abrasion of the belt generated when the belt meanders, therefore increasing durability of the belt.

### BRIEF DESCRIPTION OF THE DRAWINGS

Since the drawings are provided as a reference for describing an illustrative embodiment in the present disclosure, technical aspects of the present disclosure should not be interpreted as being limited by the accompanying drawings.

FIG. 1 illustrates a schematic view of a double belt press according to an exemplary embodiment in the present disclosure.

FIG. 2 illustrates a block diagram of a double belt press according to an exemplary embodiment in the present disclosure.

FIG. 3 illustrates a schematic view of a pressure supply unit of the double belt press according to the exemplary embodiment in the present disclosure.

FIG. 4 illustrates a schematic view for explaining detection of meandering of a belt by a position detecting sensor according to an exemplary embodiment in the present disclosure.

FIGS. 5A-5C illustrate an operation of a double belt press according to an exemplary embodiment in the present disclosure.

FIG. 6 illustrates a flowchart for explaining operation of a double belt press according to an exemplary embodiment in the present disclosure.

### DETAILED DESCRIPTION OF THE EMBODIMENTS

The present disclosure will be described more fully hereinafter with reference to the accompanying drawings, in which exemplary embodiments are shown. As those skilled in the art would realize, the described embodiments may be modified in various different ways, all without departing from the spirit or scope of the present invention.

Parts not relevant to the present invention will be omitted for describing the present invention clearly, and throughout the specification, identical or similar parts will be given the same reference numbers.

Further, since sizes and thicknesses of elements are shown for convenience of description, the present invention is not limited to the drawings without fail, but the thicknesses are enlarged for clearly expressing different parts and regions.

Hereafter, a double belt press according to an exemplary embodiment in the present disclosure will be described in detail with reference to the attached drawings.

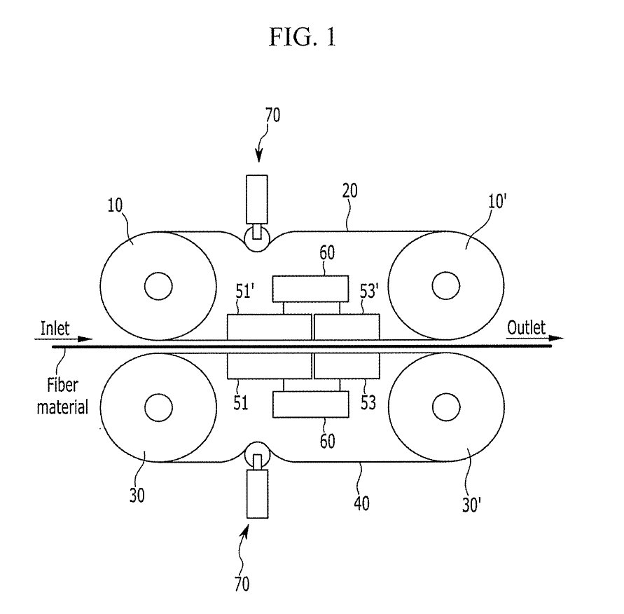

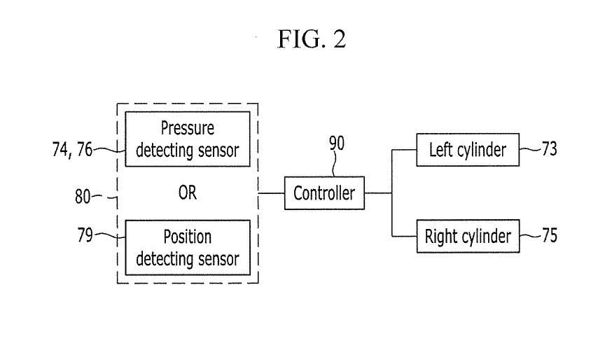

FIG. 1 illustrates a schematic view of a double belt press according to an exemplary embodiment in the present disclosure. FIG. 2 illustrates a block diagram of a double belt press according to an exemplary embodiment in the present disclosure.

As shown in FIGS. 1 and 2, the double belt press according to the present disclosure includes a pair of belts 20 and 40. A first pair of convey rollers 10 and 10′, and a second pair of convey rollers 30 and 30′ are respectively disposed in the pair of belts 20 and 40. A detector 80 detects meandering of the belts 20 and 40. A pressure supply unit 70 supplies pressure to the belts 20 and 40. A controller 90 controls the first pair of convey rollers 10 and 10′, and the second pair of convey rollers 30 and 30′, and the pressure supply unit 70.

The pair of belts 20 and 40 are respectively disposed at an upper side and a lower side of a continuously supplied fiber material, and convey the fiber material while pressing the fiber material from the upper and lower sides. The first pair of convey rollers 10 and 10′ and the second pair of convey rollers 30 and 30′ are respectively disposed in the pair of belts 20 and 40, and convey the pair of belts 20 and 40. One pair of the first pair of convey rollers 10 and 10′ and the second pair of convey roller 30 and 30′ may be a driving roller that receives power from a power source (not shown) and rotates, and the other pair may be a driven roller that rotates depending on the driving roller.

A first pair of heat plates 51′ and 53′ and a second pair of heat plates 51 and 53 are respectively disposed in the pair of belts 20 and 40 for heating or cooling the fiber material.

The first pair of heat plates 51′ and 53′ and the second pair of heat plates 51 and 53 are respectively connected to a pressing device 60. The pressing device 60 supplies pressure to the pair of belts 20 and 40 through the heat plates 51′, 53′, 51, and 53, and thus, supplies the pressure to the fiber material passing between the pair of belts 20 and 40.

A portion at which the first pair of heat plates 51′ and 53′, the second pair of 51 and 53 and the belts 20 and 40 are in contact, respectively, and a portion at which the pressing devices 60 and the belts 20 and 40 are in contact, are coated with a low friction material, and thus, the pair of belts 20 and 40 can smoothly rotate. Further, the fiber material flowing between the pair of belts 20 and 40 is heated, cooled, or pressed by the pressing device 60.

The detector 80 detects whether any of the belts 20 and 40 meanders, and a detected signal regarding whether the belt meanders is transmitted to the controller 90. A detailed description of the detector 80 will be described later.

The pressure supply unit 70 prevents the belts from meandering by supplying the pressure to the belt.

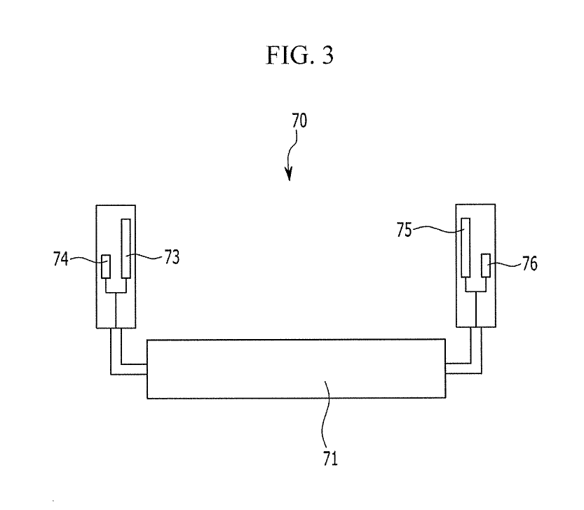

FIG. 3 illustrates a schematic view of a pressure supply unit of a double belt press according to an exemplary embodiment in the present disclosure.

Referring to FIG. 3, the pressure supply unit 70 includes a guide roll 71 disposed in a width direction of the belts 20 and 40 and contacting the belts 20 and 40. A left cylinder 73 and a right cylinder 75 are disposed at lateral sides of the guide roll 71 and adjust pressure supplied to the guide roll 71. The left cylinder 73 and the right cylinder 75 are operated by a control signal of the controller 90.

The left cylinder 73 and the right cylinder 75 may be hydraulic pressure cylinders operated by hydraulic pressure, or pneumatic pressure cylinders operated by pneumatic pressure. The pressure supply unit 70 may be disposed at an upper portion and a lower portion of the pair of belts 20 and 40, respectively.

The controller 90 controls the left cylinder 73 and the right cylinder 75 based on the detected signal of the detector 80, and controls the pressure supplied to the belts 20 and 40.

The controller 90 may be implemented by one or more processors operated by a predetermined program, in which the predetermined program is set to perform steps of the method for controlling the double belt press according to the present disclosure.

The detector 80 may be a left pressure detecting sensor 74 and a right pressure detecting sensor 76 that are disposed at lateral sides of the guide roll 71 for detecting pressures of opposite sides of each belt. That is, the left pressure detecting sensor 74 and the right pressure detecting sensor 76 can detect the pressure transmitted to the guide roll 71 from the belts.

The controller 90 determines whether any one of the pair of belts 20 and 40 meanders from the pressure detected by the left pressure detecting sensor 74 and the right pressure detecting sensor 76. For example, the controller 90 determines that the belt meanders when a pressure difference detected by the left pressure detecting sensor 74 and the right pressure detecting sensor 76 is greater than a reference pressure.

When the pressure difference detected by the left pressure detecting sensor 74 and the right pressure detecting sensor 76 is greater than the reference pressure (that is, when one of the belts meanders), the controller 90 determines in which direction the belt meanders (for example, left direction or right direction) by comparing a pressure detected by the left pressure detecting sensor 74 to a pressure detected by the right pressure detecting sensor 76. The controller 90 may increase the pressure generated from a cylinder positioned at which the detected pressure is lower than the other cylinder. The controller 90 may decrease the pressure generated from a cylinder at which the detected pressure is higher than the other cylinder. That is, since the belt meanders (in other words, the belt moves in a particular direction), the controller 90 controls the pressure generated from the cylinder positioned at which the detected pressure is lower to be greater than that generated from the other cylinder positioned at which the detected pressure is higher.

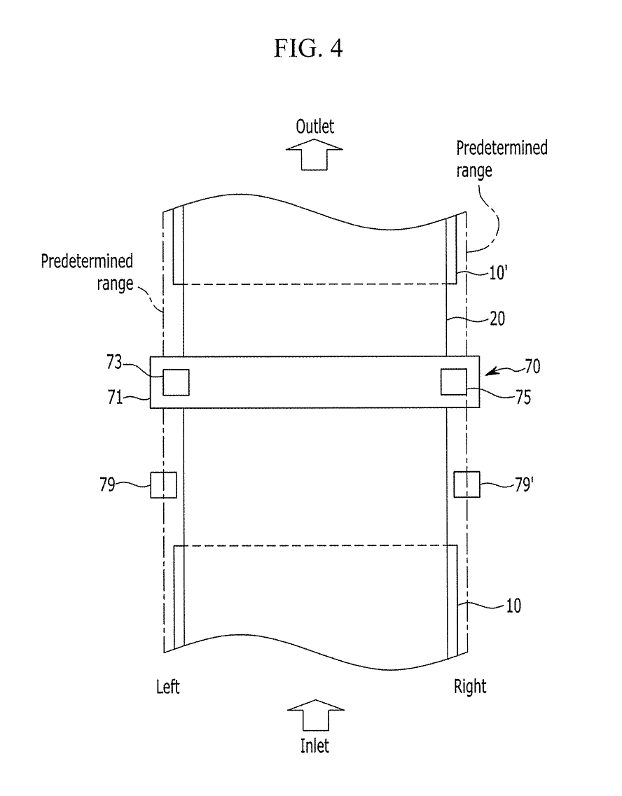

Referring to FIG. 4, the detector 80 may include a position detecting sensor 79 detecting a position of the belts. The position detecting sensor 79 (or 79′) may be a hole sensor, a laser sensor, or a photonic sensor for detecting movement of the belts.

The controller 90 determines that one of the belts meanders when a position of the belt detected by the position detecting sensor 79 (or 79′) is beyond a reference range.

When the controller 90 determines that any one of the belts 20 and 40 meanders using the position detecting sensor 79 (or 79′), the controller 90 increases the pressure generated from a cylinder positioned at which the belt is beyond the reference range. The controller 90 may decrease the pressure generated from the cylinder positioned at which the belt is within the reference range. That is, the controller 90 increases the pressure generated from the cylinder positioned at which the belt is beyond the reference range to be greater than the pressure generated from the cylinder positioned at which the belt is within the reference range.

Hereinafter, an operation of the double belt press according to an exemplary embodiment in the present disclosure will be described in detail. Here, it is assumed that the detector 80 is a pressure detecting sensor.

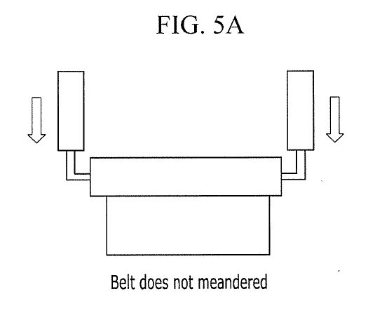

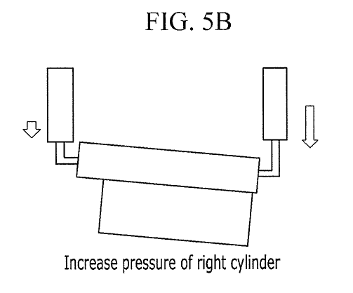

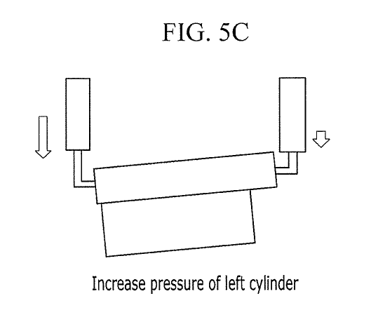

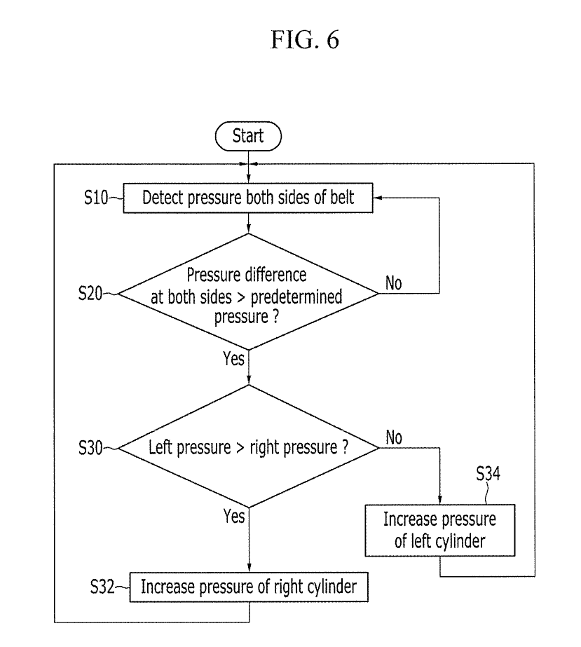

FIG. 5 illustrates a schematic view for explaining operation of a double belt press according to an exemplary embodiment in the present disclosure. In FIG. 5, sizes of arrows denote the magnitudes of pressure generated by the cylinders 73 and 75. FIG. 6 illustrates a flowchart for explaining an operation of a double belt press according to an exemplary embodiment in the present disclosure.

Referring to FIGS. 5A to 6, the detector 80 detects pressures at both sides of the belts, and transmits them to the controller 90 by converting the detected pressures to electric signals at step S10.

The controller 90 determines that any one of the belts meanders when a pressure difference at both sides of the belt is greater than a reference pressure at step S20.

If a pressure difference of the both sides of the belt is less than the reference pressure, the controller 90 determines that the belts do not meander, and maintains the pressure generated by the left cylinder 73 and the right cylinder 75 (refer to FIG. 5A).

If the pressure difference of the both sides of the belts is greater than the reference pressure, the controller 90 compares the pressure detected by the left pressure detecting sensor 74 to the pressure detected by the right pressure detecting sensor 76 at step S30.

If the pressure detected by the left pressure detecting sensor 74 is greater than the pressure detected by the right pressure detecting sensor 76, the controller 90 determines that one of the belts meanders in a rightward direction and controls the pressure generated from the right cylinder 75 to be greater than the pressure generated from the left cylinder 73 at step S32 (refer to FIG. 5B).

Then, if the pressure difference between the pressure detected by the left pressure detecting sensor 74 and the pressure detected by right pressure detecting sensor 76 is less than the reference pressure, the controller 90 determines that the belt does not meander and maintins the pressure generated from the left cylinder 73 and the right cylinder 75 (refer to FIG. 5A).

If the pressure detected by the right pressure detecting sensor 76 is greater than the pressure detected by the left pressure detecting sensor 74, the controller 90 determines that one of the belts meanders in a leftward direction and controls the pressure generated from the left cylinder 73 to be greater than the pressure generated from the right cylinder 75 at step S34 (refer to FIG. 6 (c)).

Then, if the pressure difference between the pressure detected by the left pressure detecting sensor 74 and the pressure detected by right pressure detecting sensor 76 is less than the reference pressure, the controller 90 determines that the belt does not meander and maintains the pressure generated from the left cylinder 73 and the right cylinder 75 (refer to FIG. 5A).

As described above, according to the present disclosure, it is possible to prevent a belt from meandering by adjusting the pressure supplied to both sides of the belt through a pressure supply unit.

While this invention has been described in connection with what is presently considered to be practical exemplary embodiments, it is to be understood that the invention is not limited to the disclosed embodiments, but on the contrary, is intended to cover various modifications and equivalent arrangements included within the spirit and scope of the appended claims.

What is claimed is:

1. A double belt press comprising:
a pair of belts respectively disposed at an upper side and a lower side of a fiber material, which is supplied to the pair of belts, the pair of belts at the upper side and the lower side rotating in opposite directions for pressing the fiber material from the upper side and the lower side while conveying the fiber material;
at least two convey rollers disposed in the pair of belts for moving the pair of belts;
a detector configured to detect whether the pair of belts meander;
a pressure supply unit configured to supply pressure to the pair of belts; and
a controller configured to control the pressure supplied to both sides of each belt through the pressure supply unit when any one of the belts meanders according to a detection result from the detector.

2. The double belt press of claim 1, wherein the pressure supply unit includes:
a guide roll disposed on the pair of belts in a width direction of the belts and contacting the belts; and
a left cylinder and a right cylinder disposed at respective sides of the guide roll and controlling the pressure supplied to the guide roll.

3. The double belt press of claim 2, wherein the detector includes a left pressure detecting sensor and a right pressure detecting sensor, and
wherein the controller determines that one of the pair of belts meanders when a pressure difference detected by the left pressure detecting sensor and the right detecting sensor is greater than a reference pressure.

4. The double belt press of claim 3, wherein when the pressure difference detected by the left pressure detecting sensor and the right detecting sensor is greater than the reference pressure, the controller compares a pressure detected by the left pressure detecting sensor to a pressure detected by the right pressure detecting sensor and increases a low pressure value generated from one of the left cylinder and right cylinder, at which the detected pressure is lower, to be greater than a high pressure value generated from the other cylinder of the left cylinder and right cylinder at which the detected pressure is higher.

5. The double belt press of claim 2, wherein the detector is a position detecting sensor that detects positions of the pair of belts, and
wherein the controller determines that one of the pair of belts meanders when a position of the one of the pair of belts detected by the position detecting sensor is beyond a reference range.

6. The double belt press of claim 5, wherein when the position of the one of the pair of belts is beyond the reference range, the controller increases a lower pressure value generated from one cylinder of the left cylinder and right cylinder, at which the one of the pair of belts is beyond the reference range, to be greater than a higher pressure value generated from the other cylinder of the left cylinder and right cylinder at which the one of the pair of belts is within the reference range.

7. The double belt press of claim 1, further comprising:
a first pair of heat plates and a second pair of heat plates respectively disposed in the pair of belts for heating or cooling the fiber material; and
a pressing device, to which the first pair of heat plates and the second pair of heat plates are respectively connected, supplying pressure to the pair of belts through the first and second pair of heat plates.

8. The double belt press of claim 7, wherein a contact portion of the first and second pair of heat plates and the pair of belts and a contact portion of the pressing device and the pair of belts are coated with a friction material.
